(19) United States
(12) Patent Application Publication
(10) Pub. No.: US 2008/0067021 A1
(43) Pub. Date: Mar. 20, 2008

(54) SHOE BRAKE FOR AN ELEVATOR DRIVE

(76) Inventor: MARCEL SCHNEIDER, Kriens (CH)

Correspondence Address: SCHWEITZER CORNMAN GROSS & BONDELL LLP, 292 MADISON AVENUE - 19th FLOOR, NEW YORK, NY, 10017, US

(21) Appl. No.: 11/851,489

(22) Filed: Sep. 7, 2007

Related U.S. Application Data
(63) Continuation of application No. PCT/CH2006/000134, filed on Mar. 3, 2005.

(30) Foreign Application Priority Data
Mar. 8, 2005 (EP) 05 405 224.6

(51) Int. Cl. F16D 51/18

(52) U.S. Cl. 188/325

(57) ABSTRACT

A shoe brake has a brake element for generating a braking force has at least one brake element that is adjustably settable relative to the brake shoe. The brake element may include an arcuate or segment-shaped base plate that fits in a corresponding arcuate or segment-shaped recess in the brake shoe and is adjustably mounted to the brake shoe by a pair of side panels.

The invention relates to a shoe brake for a lift drive with at least two brake shoes, which generate a braking force at a brake drum and are releasable. The present application is a Continuation of PCT/CH2006/000134, filed 3 Mar. 2005.

### BACKGROUND OF THE INVENTION

An internal shoe brake with two brake shoes has become known from the specification of JP 57107443. Two brake elements are provided per brake shoe, wherein a cut-out into which the brake element is insertable is provided at the brake shoe for each brake element. The brake element consists of a base plate carrying a brake lining, wherein the brake element fits into the shape on the arc of the brake shoe. The brake element inserted into the cut-out in the brake shoe is fixed in place at the brake shoe by means of clips.

The complicated production of the groove-shaped cut-outs is disadvantageous. Moreover, the brake elements can stick in the cut-outs due to contamination and abrasion dust.

The present invention is intended to avoid such disadvantage and to create a shoe brake which functions in an optimum manner under difficult operating conditions with brake elements arranged at brake shoes.

### BRIEF SUMMARY OF THE INVENTION

The present invention is a shoe brake having brake shoes with brake elements carrying brake linings that are measurably mounted to the shoe. The positioning of the brake elements with respect to the shoe to which it is mounted is settable, thus allowing the orientation of the brake linings to be adjusted.

The advantages achieved by the invention are substantially to be seen in that an optimum setting of the brake linings on the brake drum can be achieved by the brake elements according to the invention. With an optimum setting of the brake linings, small brake moment adjustments can be made in the final checking at the factory. In addition, tolerances of all brake parts can be accounted for, wherein also wider tolerances can be accommodated. Wider tolerances in turn mean cheaper production of the brake parts. In addition, it is advantageous that the brake elements are easily releasable from the brake shoes, because they cannot be fixed by either abrasion dust or by contamination. The shape of the brake element and the cut-out at the brake shoe guarantees even after long operating times a precise placing of the brake elements on the brake shoes.

### BRIEF DESCRIPTION OF THE DRAWINGS

The present invention is explained in more detail in the following detailed description of a preferred, but nonetheless illustrative embodiment thereof, in association with the accompanying figures, in which:

FIG. 1 is a perspective illustration, partially in section, of an internal shoe brake in accordance with the invention;

FIG. 1a is an elevation view of a shoe brake of the invention with two brake shoes;

FIG. 2 is a schematic illustration of a portion of a brake shoe according to the invention with brake element;

FIG. 3 is a view of the brake shoe of FIG. 2, further showing a side panel for fastening of the brake element;

FIG. 4 is a perspective view of a brake shoe for an internal shoe brake; and

FIG. 5 is a perspective view of a brake shoe for an external shoe brake.

### DETAILED DESCRIPTION OF THE INVENTION

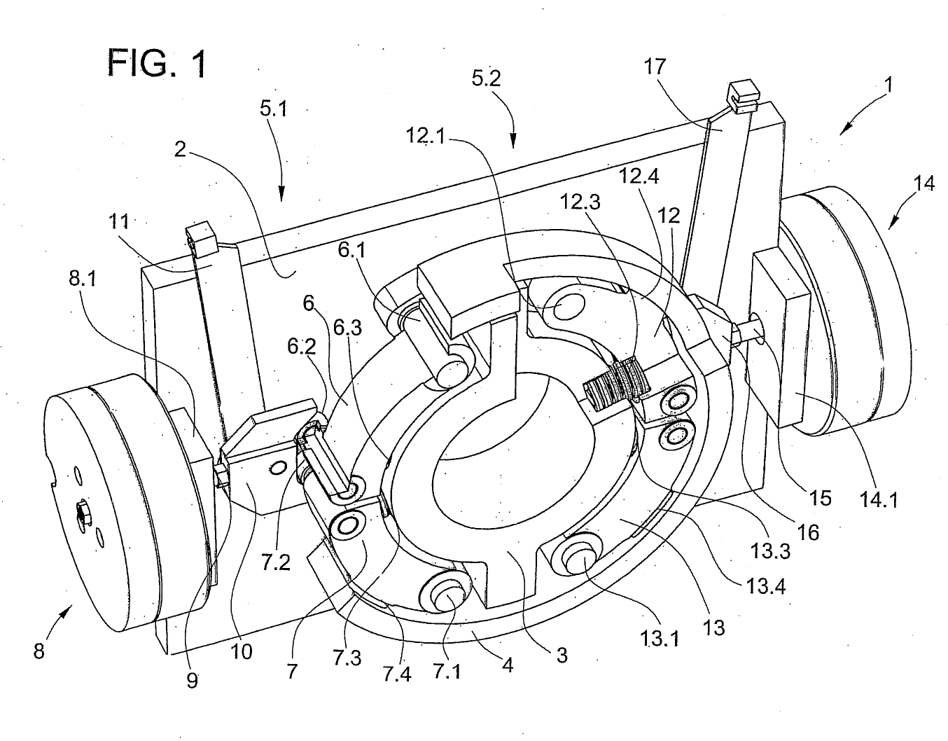

FIG. 1 is a perspective illustration of an internal shoe brake consisting of a housing plate 2, a housing ring 3, a brake drum 4 and two brake halves 5.1, 5.2 of identical construction. The brake drum 4 can be, for example, part of a drive pulley. The lefthand brake half 5.1 comprises an upper brake shoe 6 and a lower brake shoe 7. The upper brake shoe 6 is mounted at an upper brake bearing 6.1 and has at the opposed free end an actuating roller 6.2, and is pressed against the brake drum 4 by means of a compression spring 6.3 supported by the housing ring 3. The upper brake shoe 6 is illustrated in section, for which reason its brake lining is not apparent in FIG. 1. The section also runs through the roller axis at which the actuating roller 6.2 is arranged. The lower brake shoe 7 is constructed in mirror image to the upper brake shoe 6. Parts of the lower brake shoe are provided with the following reference numerals: shoe bearing 7.1, actuating roller 7.2, compression spring 7.3 and brake lining 7.4. The free ends of the brake shoes 6, 7 are adjacent to each other.

An actuator in the form of a brake magnet is provided for release of the brake shoe pair 6, 7. The actuator 8, which is arranged at an actuator plinth 8.1 connected with the housing plate 2, acts by means of a pushrod 9 on an actuating fork 10 by which the actuating rollers 6.2, 7.2 are acted on to roll against the spring force of the compression springs 6.3, 7.3. A brake lever 11 serves for manual release of the brake shoe 6, 7.

The right hand brake half 5.2 is constructed in mirror image to the lefthand brake half 5.1. Parts of the righthand brake half 5.2 are provided with the following reference numerals: upper brake shoe 12 with shoe bearing 12.1, compression spring 12.3, and brake lining 12.4; lower brake shoe 13 with shoe bearing 13.1, compression spring 13.3, and brake lining 13.4, actuator 14 with actuator plinth 14.1, pushrod 15, actuating fork 16 and brake lever 17.

In left hand rotation of the brake drum 4 the brake shoes 6, 13 are trailing and the brake shoes 7, 12 leading. In a righthand rotation of the brake drum 4 the brake shoes 6, 13 are leading and the brake shoes 7, 12 trailing. The braking action is amplified in the leading brake shoes and is weakened in the trailing brake shoes.

FIG. 1a shows a shoe brake with only two brake shoes. The reference numerals of the lower brake shoes of FIG. 1 have been used for analogous parts, with actuator roller 13.2. The brake drum at which the brake linings engage is not illustrated.

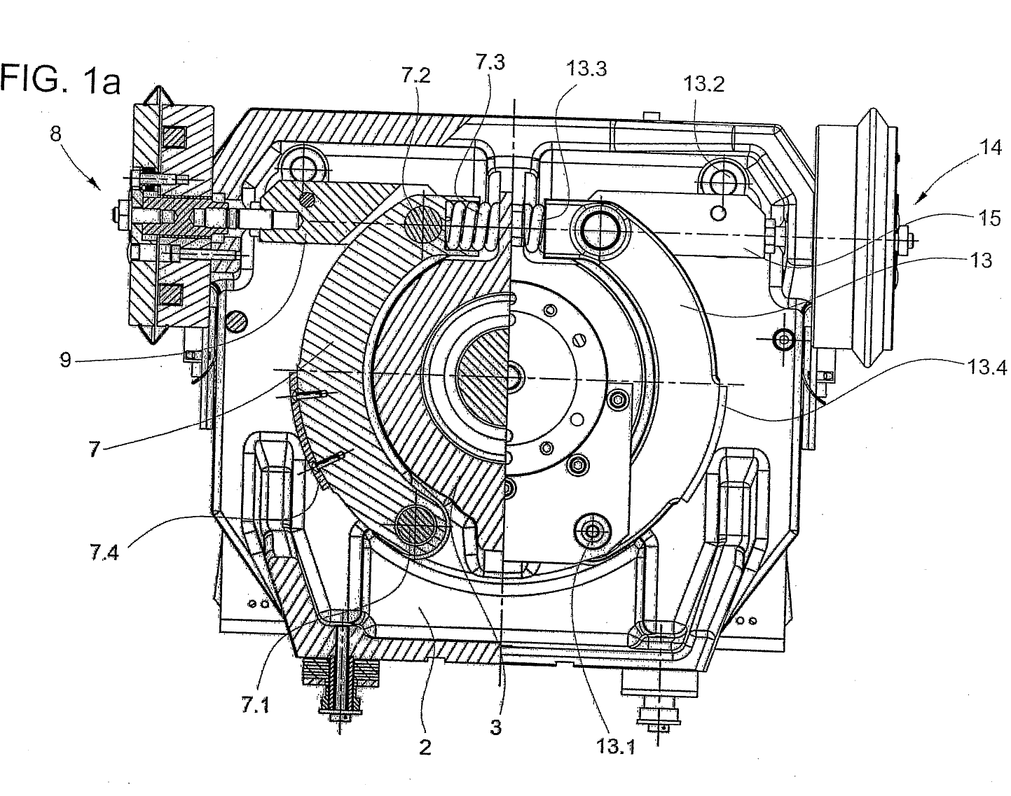

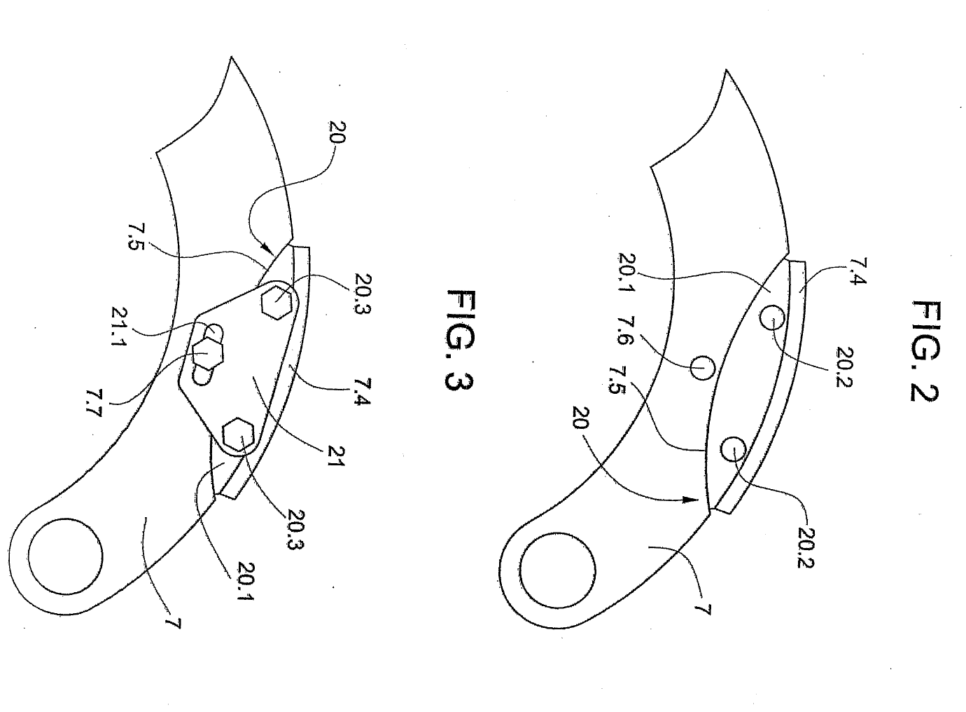

FIGS. 2 and 3 show a brake shoe according to the invention with a brake element. The lower brake shoe 7 of the lefthand brake half 5.1 of FIG. 1 is illustrated in FIG. 2 and FIG. 3. The remaining brake shoes 6, 12, 13 are of the same construction, as is a brake shoe of a shoe brake with only two brake shoes, as illustrated in FIG. 1a. The brake shoe can also be constructed with more than one brake element. Such a brake element, placeable on the brake shoe 7, is denoted by 20. The brake element 20 consists of an segment-shaped base plate 20.1 which fits in a corresponding arcuate or segment-shaped recess 7.5 of the brake shoe 7. The base plate 20.1 carries the brake lining 7.4, which is, for example, glued and pinned to the base plate. A threaded hole 7.6 is provided in the brake shoe 7, and threaded holes 20.2 are provided in the base plate 20.1. The same threaded holes are provided on the other side (not visible) of the brake shoe 7 and the brake element 20.

FIG. 3 also shows a side panel 21 which releasably connects the brake element 20 with the brake shoe 7. The side panel 21 is connected to the base plate 20.1 by means of crews 20.3, wherein the screws 20.3 fit in the threaded holes 20.2. The side panel 21 has an elongated slot 21.1, wherein a screw 7.7 extends through the longitudinal slot 21.1 and fits in the threaded hole 7.6. The longitudinal slot 21.1 allows setting of the brake element 20 relative to the brake shoe 7. The base plate 20.1 is displaceable in the segment-shaped recess 7.5, wherein the brake lining 7.4 can be adjusted on the brake drum 4. A similar side panel is provided on the other side, of the brake shoe 7 of the brake element 20.

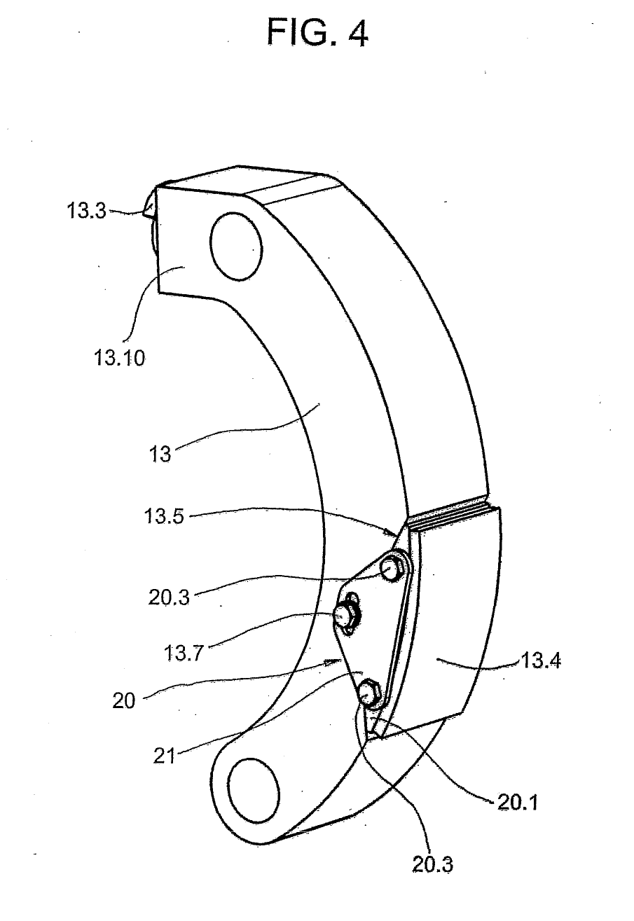

FIG. 4 shows, by way of example, a lower brake shoe 13 of the righthand brake half 5.2 with the brake element 20 according to the invention. In this construction a projection 13.10 is provided at the brake shoe 13 for reception of the compression spring 13.3. The construction of the brake element 20 with the components brake lining 13.4, recess 13.5, screw 13.7, base plate 20.1, screws 20.3, side panel 21, etc., corresponds with the brake element illustrated in FIG. 2 and FIG. 3.

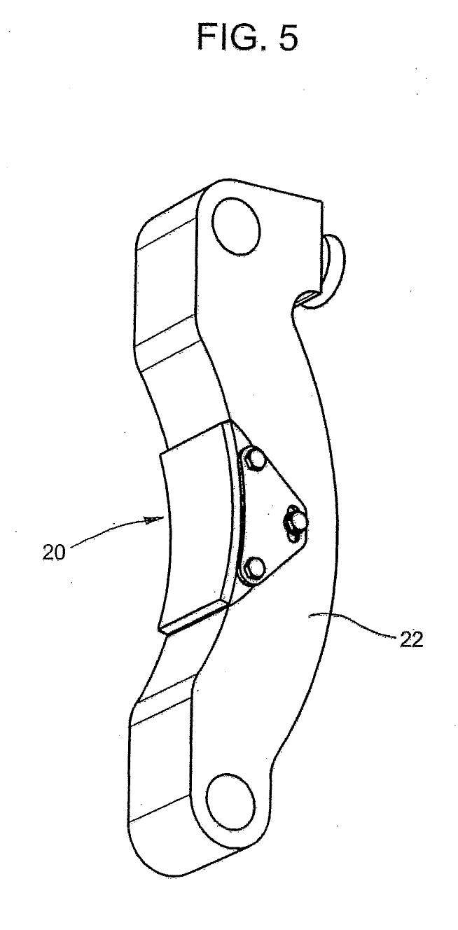

The brake element 20 can also be used for external shoe brakes. FIG. 5 shows a brake shoe 22 for an external shoe brake, in which the brake drum is braked by means of the brake element 20, which is illustrated in the preceding figures, at the outer side.

I claim:

1. A shoe brake having at least two brake shoes which produce a braking force at a brake drum, characterized in that at least one brake element for generating the braking force is fixedly settable relative to the brake shoe, is arranged at the brake shoe.

2. The shoe brake according to claim 1, characterized in that the brake element comprises a segment-shaped base plate which fits in a corresponding segment-shaped recess of the brake shoe and carries a brake lining.

3. The shoe brake according to claim 1 or 2, characterized in a side panel releasably connects the brake element with the brake shoe.

4. The shoe brake according to claim 3, characterized in that the side panel has a longitudinal slot and a screw extends through the longitudinal slot and fits in a threaded hole of the brake shoe, wherein the longitudinal slot allows adjustment of the brake element relative to the brake shoe.

5. The shoe brake according to claim 4, wherein a side panel is provided on each of opposed sides of the brake shoe.
